(19) United States
(12) Patent Application Publication
(10) Pub. No.: US 2013/0110737 A1
(43) Pub. Date: May 2, 2013

(54) NETWORKED STUDENT INFORMATION COLLECTION, STORAGE, AND DISTRIBUTION

(71) Applicants: Alexander Shustorovich, New York, NY (US); Olga Zakharova, Moscow (RU); Natalia Churakova, Moscow (RU)

(72) Inventors: Alexander Shustorovich, New York, NY (US); Olga Zakharova, Moscow (RU); Natalia Churakova, Moscow (RU)

(73) Assignee: Pleiades Publishing Limited Inc., New York, NY (US)

(21) Appl. No.: 13/347,376

(22) Filed: Jan. 10, 2012

Related U.S. Application Data
(60) Provisional application No. 61/551,908, filed on Oct. 26, 2011.

(51) Int. Cl. G06Q 50/20

(52) U.S. Cl. 705/326

(57) ABSTRACT

Systems and methods for collecting information about a student's educational and social activities from a plurality of networked sources, storing the information, and providing access to the information are provided. A collection component receives information associated with a student, including at least educational activity information. A portfolio component then associates the information in a portfolio for the student, which is stored in a data store, and an access component provide access to the portfolio. In an aspect, the collection component receives the information from an external source, such as an interactive electronic application, over a network in response to receipt of the information by the external source.

PRIORITY CLAIM

This application claims priority to U.S. Provisional Patent Application Ser. No. 61/551,908, filed on Oct. 26, 2011, entitled “ELECTRONIC PORTFOLIO AS A SCHOOL STUDENT'S SOCIAL PROFILE FORMING TOOL.” The entirety of the aforementioned application is incorporated by reference herein.

### TECHNICAL FIELD

This disclosure relates to collecting information about a student's educational and social activities from a plurality of networked sources, storing the information, and providing access to the information.

### BACKGROUND

Conventional educational technologies utilize computer-aided systems; however, such technologies lack digital teaching aids oriented towards efficient instruction. In addition, conventional educational technologies lack an efficient and effective means to monitor and present not only educational progress of the student but social progress as well.

The above-described deficiencies of today's educational and related technologies are merely intended to provide an overview of some of the problems of conventional technology, and are not intended to be exhaustive. Other problems with the state of the art, and corresponding benefits of some of the various non-limiting embodiments described herein, may become further apparent upon review of the following detailed description.

### SUMMARY

The following presents a simplified summary of the disclosure in order to provide a basic understanding of some aspects of the disclosure. This summary is not an extensive overview of the disclosure. It is intended to neither identify key or critical elements of the disclosure nor delineate any scope particular embodiments of the disclosure, or any scope of the claims. Its sole purpose is to present some concepts of the disclosure in a simplified form as a prelude to the more detailed description that is presented later.

In accordance with one or more embodiments and corresponding disclosure, various non-limiting aspects are described in connection with automatically collecting information about a student's educational and social activities from a plurality of networked sources, storing the information, and providing access to the information.

In accordance with a non-limiting embodiment, in an aspect, a system is provided comprising a collection component configured to receive information associated with a student, including at least educational activity information from one or more external sources over a network in response to receipt of the information by one or more external sources. In turn, a portfolio component is configured to associate the information in a portfolio for the student, and an access component configured to provide access to the portfolio as stored in a data store. In an aspect, the one or more external sources include an interactive educational application employed on a computer, and wherein the educational activity information includes quantitative and qualitative educational information generated through use of the interactive educational application. For example, the one or more external sources can include at least one of, an educational portal, an educational social network, or an electronic interactive library.

In another non-limiting embodiment, provided is a method, comprising receiving information associated with a student, including at least educational activity information, from one or more external sources over a network in response to receipt of the information by one or more external sources, associating the information in a portfolio for the student, receiving authentication information, and providing access to the portfolio as stored in a data store based on the authentication information. In an aspect, the one or more external sources include an interactive educational application employed on a computer, and wherein the educational activity information includes quantitative and qualitative educational information generated through use of the interactive educational application. In another aspect, the method can further comprise determining points associated with the information, analyzing the information based on the points, determining a score associated with the information that reflects at least one of student educational performance or student social performance, and associating the score with the portfolio.

Further provided is a computer-readable storage medium comprising computer-readable instructions that, in response to execution, cause a computing system to perform operations, comprising: receiving information associated with a student, including at least educational activity information, from one or more external sources over a network in response to receipt of the information by one or more external sources, associating the information in a portfolio for the student, and providing access to the portfolio as stored in a data store. In an aspect, the one or more external sources include an interactive educational application employed on a computer, and wherein the educational activity information includes quantitative and qualitative educational information generated through use of the interactive educational application.

The following description and the annexed drawings set forth certain illustrative aspects of the disclosure. These aspects are indicative, however, of but a few of the various ways in which the principles of the disclosure may be employed. Other advantages and novel features of the various embodiments of the subject disclosure will become apparent from the following detailed description of the disclosure when considered in conjunction with the drawings.

### BRIEF DESCRIPTION OF THE DRAWINGS

FIG. 1 illustrates an example non-limiting student portfolio system in accordance with an embodiment.

FIG. 2 illustrates presents a non-limiting diagram of the various sources from which the collection component of a student portfolio system can receive student information.

FIG. 3 presents a non-limiting block diagram of an example configuration of the possible sources of student information and types of information associated therewith, which may be contribute to a portfolio

FIG. 4 illustrates another example non-limiting student portfolio system in accordance with an embodiment.

FIG. 5 presents an block diagram of an example organizational scheme which the presentation component may follow when organizing student information in a portfolio for a student.

FIG. 6 illustrates another example non-limiting student portfolio system in accordance with an embodiment.

FIG. 7 illustrates another example non-limiting student portfolio system in accordance with an embodiment.

FIG. 8 illustrates an example methodology for receiving, storing, and distributing student information in accordance with the subject student portfolio systems.

FIG. 9 is a block diagram representing an exemplary non-limiting networked environment in which various embodiments can be implemented.

FIG. 10 is a block diagram representing an exemplary non-limiting computing system or operating environment in which various embodiments may be implemented.

### DETAILED DESCRIPTION

The various embodiments are now described with reference to the drawings, wherein like reference numerals are used to refer to like elements throughout. In the following description, for purposes of explanation, numerous specific details are set forth in order to provide a thorough understanding of the various embodiments. It may be evident, however, that the various embodiments can be practiced without these specific details. In other instances, well-known structures and components are shown in block diagram form in order to facilitate describing the various embodiments.

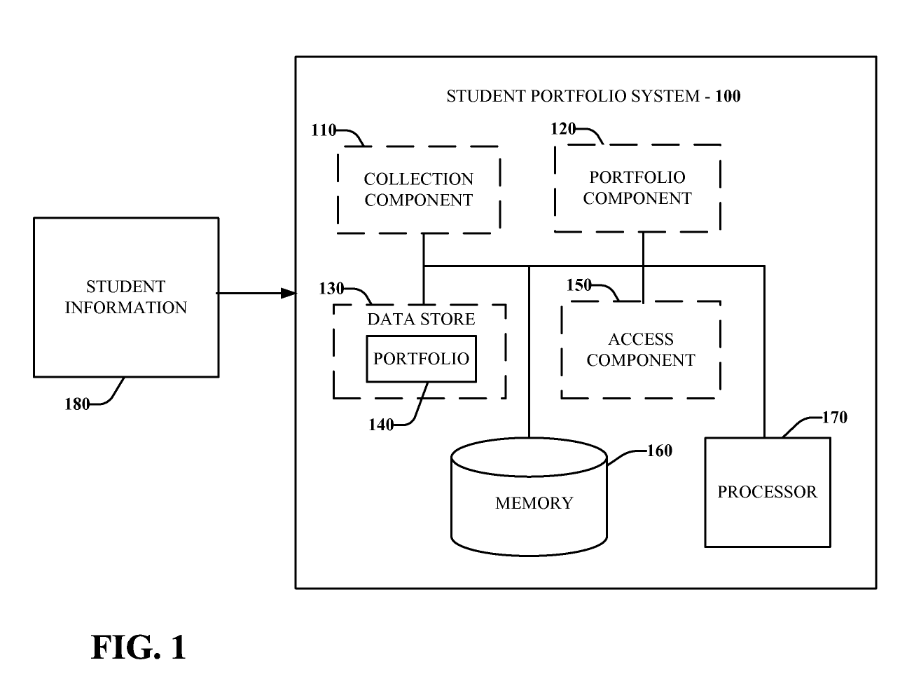

Referring now to the drawings, with reference initially to FIG. 1, a student portfolio system 100 is shown that facilitates collecting, storing, and accessing information about a student. Aspects of the systems, apparatuses or processes explained in this disclosure can constitute machine-executable component embodied within machine(s), e.g., embodied in one or more computer readable mediums (or media) associated with one or more machines. Such component, when executed by the one or more machines, e.g., computer(s), computing device(s), virtual machine(s), etc. can cause the machine(s) to perform the operations described. System 100 can include memory 160 for storing computer executable components and instructions. A processor 170 can facilitate operation of the computer executable components and instructions by the system 100.

In an embodiment, system 100 employs a collection component 110, a portfolio component 120, a data store 130, and an access component 150. Memory 160 can have stored thereon computer the above executable components, and processor 160 is configured to execute the above computer executable components stored in the memory 160. In an aspect, the collection component 110 is configured to receive information 180 associated with a student, such as educational activity information. In turn, the portfolio component 120 is configured to associate the information in a portfolio 140 for the student. Data store 130 is configured to store the portfolio 140 and access component 150 is configured to provide access to the portfolio.

In an embodiment, student portfolio system 100 can be provided in a public or private environment/network. For example, a private entity such as a school or college may employ a student portfolio system 100 to facilitate collection, storage and distribution of student information. According to this example, the student portfolio system can be provided on a server for the school and accessed via a private network, such as an intranet associated with the school. In another aspect, student portfolio system can be employed by a variety of different entities over a public network, such as the world wide web (i.e. Internet). For example, a variety of different schools, universities, and etc. can employ student portfolio system 100 via an internet to into collect, store, and distribute information about students for the variety of different schools. In particular, the subject student portfolio system is configured to receive and distribute student information over a networked environment via a cloud computing environment (e.g., via an internet based computing environment, via a Transmission Control Protocol (TCP), via an Internet Protocol (IP), etc.)

In an embodiment, collection component 110 receives information about a student which is then used to establish and/or develop a student portfolio 140. As used herein a student or pupil includes a person who attends or is enrolled at an educational institution for the purpose learning. A student can include an individual who is associated with an educational institution for the purpose of learning who is not actively participating in learning for an interrupted period of time, such as a period of time where classes are not held, or a period of time where the student is placed on leave, or probation. A graduated student is a person who attended or was enrolled at an educational institution in the past. An educational institution can include but is not limited to a pre-school, a primary school, a secondary school, a high school, a college, a university, a vocational school, an alternative school, a home school, an online school, a government school, a military school, a business school, or any other organized learning institution.

In an aspect, a student can be enrolled at multiple educational institutions over time. For example a student can be enrolled at multiple different educational institutions in a consecutive manner throughout his or her lifetime. According to this example, a student may attend pre-school, then primary school, then secondary school, then university. According to this aspect, an individual can retire from the role of a student at periods of time where the individual is not enrolled at an educational institution and re-enter the role of student when the individual again enrolls at an educational institution.

As used herein, a portfolio or student portfolio 140 includes a data file associated with an individual who is a student and includes information about the student. In other words, a portfolio 140 is associated with a single individual and includes information about that individual. A student portfolio 140 serves as a dynamic tool to organize and view information about a student's educational and/or social history. In particular, the educational and social profile of a student is formed over the whole period of the student's educational career using the changing and ever-supplemented base of individual information. The portfolio 140 serves to store this base of individual data in an organized manner, while collection component 110 receives the information 180.

In an aspect, the portfolio remains associated with an individual when the individual becomes a graduated student (i.e. no longer enrolled at an educational institution). In yet another aspect, the portfolio for an individual remains associated with the individual as the individual enrolls at multiple schools throughout his or her lifetime. For example, once a portfolio is established for a student at a first educational institution, the portfolio can remain associated with the student when the student attends another educational institution. According to this aspect, a student's portfolio serves as a compilation of information about the student over the course of the student's educational history. In another aspect, a student can be associated with a different portfolio 140 for each educational institution the student attends.

A portfolio 140 can include a variety of information about a student. In an aspect, a student can have a portfolio stored in data store 130 which is continuously developed and updated over the course of the student's educational career. For example, when an individual enrolls at an educational institution, the educational institution can establish a basic portfolio for the student comprising of various categories of information. As the student advances in his or her educational career at the educational institution (or a new educational institution for that matter), the collection component 110 can receive information to apply to the various categories and thus enable the growth and development of a rich student portfolio.

In an embodiment, a student portfolio 140 can include, and thus the collection component 110 can receive, educational activity information. Educational activity information can include any information associated with the progress of a student's education, such as participation in educational activities. For example, educational activities can include classes, other educational activities related to classes, other educational activities not related to classes, educational events, educational seminars, tutoring, educational projects, library visits, laboratory visits, studio visits, research, educational competitions, reading activities, study hall attendance, study group attendance, and etc.

In an aspect, educational activity information includes qualitative academic performance information. Qualitative academic performance information relates to the quality of a student's academic performance in educational activities including the types of academic classes and activities a student participates in, scores or grades received in those classes and activities, and scores or grades received on academic evaluations. For example, an academic evaluation can include but not limited to a test, an exam, a quiz, a project, a paper, a speech, a performance, a competition and etc. Academic performance information can include specific scores for a specific evaluation or assignment and/or general scores regarding overall academic performance. For example, academic performance information can include a final class grade or final exam score as well as a breakdown of scores on various assignments, tests, and quizzes contributing to the final class grade.

A score for an academic evaluation can include a point score, a percentage, or a grade. In addition, academic performance information can account for the quality of a score. In particular, academic performance information can weigh a score based on the difficulty of the academic evaluation used to generate the score and/or the subject matter or activity associated with the academic evaluation. For example, a final grade in an advance math class may have a higher weight then a final grade in a performance arts class. In another example, qualitative academic performance information can include scores received on activities, tests, or quizzes provided on an interactive electronic educational website.

In addition, qualitative academic performance information can account for ratings or reviews received by peers and/or teachers regarding a student's academic performance in general or with respect to an educational activity. In particular, in addition to numeric data on the quality of education, such as points and grades, the collection component can automatically receive teachers' commentaries that teachers enter in an electronic register against the last name of each student at the end of each term or each trimester. Similarly, the collection component 110 can also automatically receive teachers' opinions on students' competition entries and work in projects, (i.e. commentaries by teachers who supervise competitions and projects).

In another aspect, educational activity information can include quantitative academic performance information. Quantitative academic performance information represents an amount of participation in educational activities. For example, quantitative academic performance information can include transcript information, including degrees received, diplomas awarded, commendation certificates, a number of classes taken, and types of classes taken. In another example, quantitative educational activity information can include a number of activities participated in, a number of competitions participated in, a number of workshops attended, a number of seminar attended, a number of online assignments fulfilled, and etc. In another example, the quantitative educational activity information can include at least one of: participation in or attendance of an educational event or activity, participation in a competition or a project; receipt of an achievement award, participation in a forum, time spent at a library time spent at a laboratory or studio, or reading activity, and etc.

In another embodiment, a student portfolio 140 can include, and thus the collection component 110 can receive student information 180 including, social activity information. Social activity information can include any type of information related to participation in a social activity, wherein a social activity includes an activity that facilitates interaction and communication with others. For example, social activity information can include but is not limited to, participation in an extracurricular activity, participation in a social event or activity (i.e. a dance, a mixer, a game event, a sporting event, a fundraiser, a play, and etc.) , participation in a competition or project, or participation in a coterie.

Social activity information can also be qualitative or quantitative. For example, qualitative social activity information can account for the quality of social activity of a student with respect to participation in a social activity measured by the accumulation of friends and contacts, invitation to additional social events, or acceptance into coteries. Qualitative social activity information can also be provided in the form of commentary provided by peers, teachers, or supervisors regarding the quality of a student's social performance in social activities. Quantitative social activity information can include the number of social activities attended by or participated in by a student, as well as the types of those activities.

Still, in an aspect, a student portfolio 140 can include, and thus the collection component 110 can receive, additional personal information about a student which may be relevant to the student's educational and social performance. For example, additional information can include medical information about a student, such as current vaccinations, diseases, or other medical conditions, including psychological conditions, as well as medications taken by a student. In another example, other personal information can include information related to a student's behavioral activities, such as a student's criminal record, a student's policy violations, a student's detentions and/or expulsions, and etc. In another example, additional personal information can include information about a student's background, or family life.

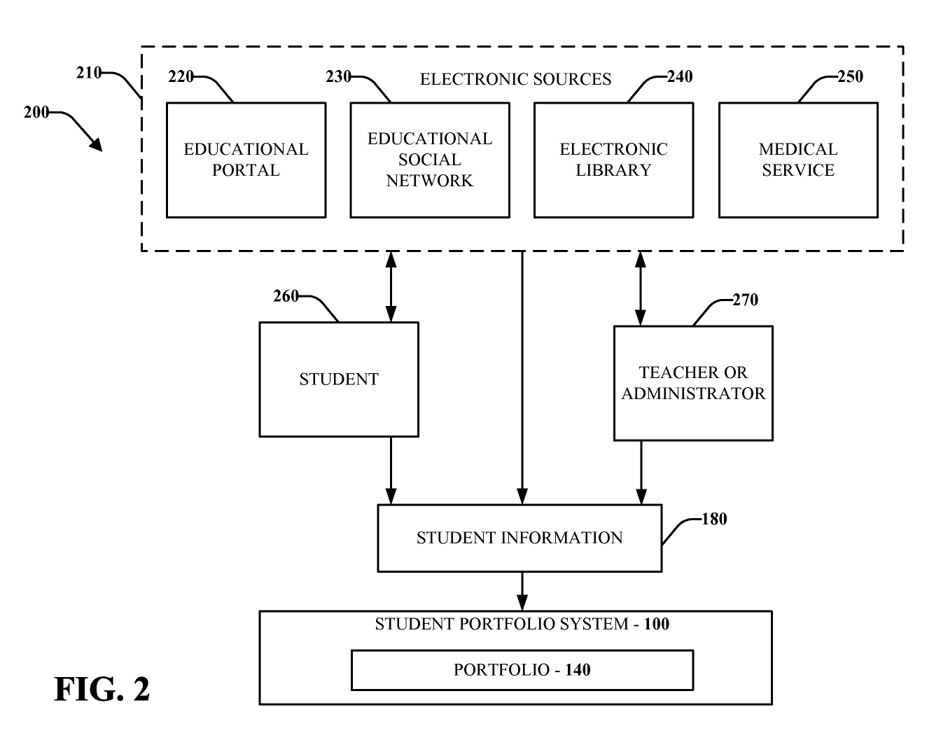

FIG. 2 presents a non-limiting diagram 200 of the various sources from which the collection component 110 of student portfolio system 100 can receive student information 180. As see in FIG. 2, collection component 110 can receive information 180 about a student from a variety of sources. In an embodiment, collection component 110 can receive information 180 about a student automatically over a network. According to this embodiment, the collection component 110 is configured to receive the information 180 from an external electronic source 210 over a network in response to receipt of the information by the external electronic source 210.

For example, the external electronic source 210 can include an interactive educational application employed on a computer, configured to generate quantitative and qualitative educational and/or social activity information. According to this example, a student may employ an interactive learning website to perform training exercises and take tests. The website can produce information such as the number of training exercises completed and the scores the student received on the tests. In response to the completion of a test or the generation of a test score, the website can provide the information to the collection component 110, and thus the collection component 110 can automatically receive the information upon generation by the external electronic source 210. In an embodiment, the external electronic sources from which the collection component 110 can receive student information 180 include one or more of an educational portal 220, an educational social network 230, an electronic interactive library 240, or medical service 240.

In an embodiment, the external electronic sources from which the collection component 110 of student portfolio system 100 can receive student information 180 include one or more of an educational portal 220, an educational social network 230, an electronic interactive library 240, or medical service 240.

In an embodiment, educational portal 220 includes a networked based education system that facilitates providing and storing educational information. In addition, the educational portal 222 can serve as a forum for communication and blogging of students, teachers and administrators. In an aspect, the educational portal is situated at a server computer and accessed by a device via cloud computing. For example, the educational portal can be presented to users as a website over the World Wide Web.

The server of the educational portal 220 can include information storage facilities, information transmission facilities (to transfer materials from the server to the student devices), information collecting media (to obtain the necessary teaching material), presentation media (to present materials selected by students); a scoring system to assess student progress, media to identify personal information about each student (a student or a teacher can obtains access to the educational portal only if they have registered with the educational portal).

In an aspect, the education portal 220 stores, provides and receives teaching material, and evaluation material. The educational portal can further receive and store qualitative academic performance information for students, including scores and grades associated with classes, scores and grades associated with academic evaluation material, and scores and grades associated with other teaching material. For example, the educational portal can serve as an electronic registrar of student grades and points and provide dynamic representations of a student's educational progress in various subjects based on points received on evaluation material. In addition, the educational portal can also store a log or diary for a student with points and scored received by the student for additional educational and social activities.

According to an embodiment, the collection component 110 of system 100 can automatically receive (in response to receipt at the education portal 220), any information received and stored by the education portal 220, including qualitative educational activity information. The qualitative educational activity information can be received by collection component 110 from various sections of the educational portal 220 associated with a student, and include information such as data about a student's academic progress in all subjects, including both the student's current academic progress and results of tests and final tests. The data received can be represented in two formats: (1) points and 2) grades according to a five-point scale.

In an embodiment, the contents of educational portal 220 are controlled, regulated, and obligatory, (i.e. all information contained by the educational portal 220, organizational forms, and tools used. For example, the educational portal can provide only teaching materials that have been approved by the government and that have analogs in the Federal List of Textbooks Authorized for the educational institution. In another example, the educational portal may only contain the compulsory list of teaching materials that comply with the basic curriculum, (i.e. only each specific school's timetable of classes in the form of 40- or 45-minute lessons and signed by the administration of this school may be uploaded to it; the portal may use only those forms of control (test and control works, various test forms) that are currently topical in the state educational space; only those forms of reporting (diaries, registers) are employed that are traditional for the modern school; and etc). Detailed information regarding educational portal 220 can be found in U.S. patent application Ser. No. 13/010,997, the entirety of which is herein incorporated by reference.

Educational social network 230, is a network that links students, teachers and administrative personal in both an educational and social manner and generates and stores information about a student's educational and social activities. Educational social network can be situated on one or more server computers that can communicate with devices of students, teachers and/or administrators over a network via cloud computing. Students can employ educational social network to share information regarding educational and social activities, such as participation in projects and competitions. Students and teachers can also share educational information, comments on one another's educational and social activities, join social and/or educational groups, suggest events and activities to attend, and etc. Students can employ educational and social network to collaborate on ideas and projects and receive answers to question, participate in a discussion forum, participate in a real-time streaming seminar or interactive discussion, and etc. Not only can students, share messages with other students and teachers via the educational and social network 230, students can vote and rate one another's quality of participation in educational and social activities. Students and teachers can further form online communities with the educational and social network

In an embodiment, the collection component 110 of system 100 automatically receives information from the educational and social network 230 related to participation in network competitions and projects. In particular, the collection component 110 can receive both quantitative data about a student's participation in various projects, competitions, Olympiads, and etc., held with the help of the educational-social network, and qualitative indicators of the student's progress as the result of these events (i.e. what the student has scored following the voting results associated with the educational and social activities held on the educational and social network).

In addition to these quantitative and qualitative indicators, the collection component 110 can also receive information regarding social activities in all events that are outside the educational social network 230, yet discussed or revealed through posting and communication via the educational and social network. For example, the educational social network may gather and generate information regarding a student's attendance of coteries, studios, and workshops, which are located both inside and outside an affiliated school, participation in competitions, Olympiads, contests, and other events organized outside the educational-social network, visits to museum expositions and temporary exhibitions, theatrical performances, and movies, performances, installations, etc. In an aspect, a student enters all this information in different rubrics of the educational social network 230. For example the educational social network 230 can include personal areas for each student entitled “My Wall of Achievements,” “My Participation in Coteries, Workshops, and Studios,” “My Cultural Life Outside the School,” and “My Best School and Nonschool Works.” In an aspect, the student can supply information under any of the above noted areas to the educational and social network. This information can further be received by the collection component 110 and included in a student's portfolio. As a result, this information is also accounted for in the overall indicators of the school student's social and education activities and improves the rating of his/her portfolio 140. Detailed information regarding educational social network can be found in U.S. patent application Ser. No. 61/566,380, the entirety of which is herein incorporated by reference.

Electronic interactive library 240, includes a networked system for accounting for a student's reading activities. Electronic interactive library 240 can include one or more server computers configured to receive and store information over a network. From the electronic interactive library 240, the collection component 110 can receive both quantitative indicators regarding a student's educational activities associated with reading and studying. In an aspect, electronic interactive library can receive and log quantitative information from a virtual and/or physical library system indicating books checked out and returned by students. The electronic interactive library can further receive and log quantitative information regarding time spent at a library. For example, the electronic interactive library store information in an area entitled “Library Card” which logs information associated with books checked out, and visits to the library.

In addition, the electronic interactive library 240 can provide a forum for students to post annotations and review on books, take quizzes or tests regarding books read, take quizzes or tests which evaluate reading competence, or participate in reading competitions. For example, the electronic interactive library 240 can include an area for students to post information about the books they have read entitled “My line of opinions on what I have read.” The collection component 110 can automatically receive any information generated by or provided to the electronic interactive library 240.

In an aspect, the very fact of participation in competitions held by the electronic interactive library 240 give a glimpse of not only the school student's reading activity but also his/her reading competence. For example, the number of feedbacks to a book review posted by the student in the Line of Opinions is a qualitative indicator of the school student's (author of the review) reading competence. Similarly, a student may receive ratings of his or her performance in competitions held by the electronic interactive library. Such rating can also serve as qualitative information regarding reading competence. The collection component 110 can thus receive from electronic interactive library, information about a student's reading activity, his or her artistic preferences, and the general direction of development of his or her reading competence.

Medical service 250 can include an electronic medical records accounting system. In an aspect, medical service 250 can receive and store information about a student's medical history, such as current vaccinations, diseases or illnesses of the student, doctors appointments, medications of taken or currently being taken by a student, and any additional medical information. For example, medical service can provide collection component 110 with a student's health certificate.

In addition to the above noted electronic sources 210 of student information 180, in another aspect, an individual can directly provide student information 180 to the collection component 110. According to this aspect, a student 260, teacher/administrator 270, or otherwise authorized entity or individual, can directly provide the collection component 110 with information about the student. For example, a student may access his or her portfolio and provide the collection component 110 information to be included in his or her portfolio. In another example, a teacher may access a student's portfolio and provide information to be included in the portfolio, such as comments and remarks about the student.

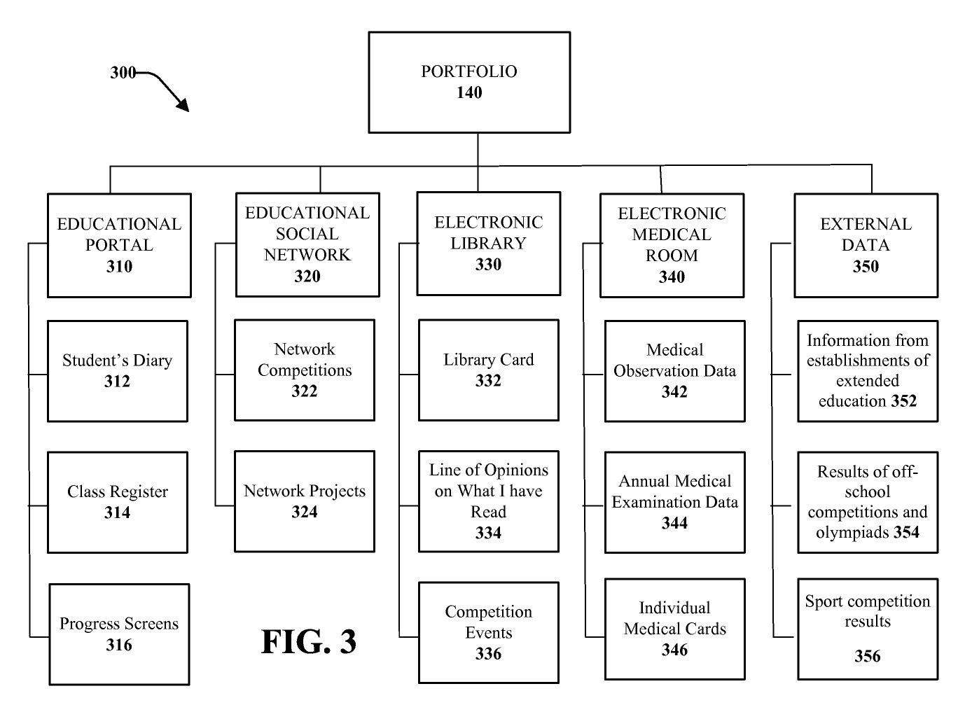

FIG. 3 presents a non-limiting block diagram of an example configuration 300 of the possible sources of student information and types of information associated therewith, which may be contribute to a portfolio 140. As seen in FIG. 3, portfolio can receive information from educational portal 310, educational and social network 320, electronic library 330, electronic medical room 340, and external data 350. In an aspect, the educational portal 310 can send the collection component 110 information from areas of the educational portal comprising a student's diary 312, a class register 314, and/or educational progress information. Educational and social network 320 can send the collection component 110 information from areas comprising network competition information 322, and/or network project information 324. Electronic library 330 can send the collection component 110 information from areas comprising library card information 332, information associated with lines of opinions on what the student has read 334, and/or events or competitions associated with reading 336. Electronic medical room 340 can send the collection component information from areas comprising medical observation data 342, annual medical examination data 344, and/or individual medical card information 346. Further, the communication component can receive external data 35 from any other external source which may include for example, information from establishment of extended education 352, results of off-school competitions and Olympiad 354, and/or sport competition results 356.

Referring back to FIG. 1, portfolio component 120 is configured to associate student information 180 received by collection component 110 in a portfolio for a student. It should be appreciated that although system 100 may be described with reference to a student, system 100 can accommodate a plurality of students. In particular, collection component 110 can receive information about a plurality of students. For example, collection component 110 can receive information about the multiple students attending a specific educational institution. In another aspect, collection component 110 can receive information about a plurality of students attending a plurality of different educational institutions.

In an embodiment, portfolio component 120 is configured to identify a student for which student information is received and associate the information with the portfolio of that student. In an aspect, the portfolio component 120 can identify a student by a name or last name associated with the student and the information received. In another aspect, the portfolio component 120 can identify a student by an account number or IP address associated with information received and associated the information the portfolio of that student as identified by the students name, account number, IP address, or other identification number for the student.

In another aspect, wherein the portfolio component 120 is further configured to organize the portfolio into categories based on features of the student information received. For, example, the portfolio component 120 is configured to classify information received by collection component 110 into one or more predetermined classifications and file the information based on the classification. According to this example, each of the types of information 312-316, 322-324, 332-336, 342-346, and 352-356 presented in FIG. 2 can be considered categories of information. In another aspect, the portfolio component can organize and file received student information 180 based on its origination source.

Data store data store 130 is configured to store portfolios 140 for students as well as additional information employed by system 100. Additional information can include student identification information, information associating students with electronic resources (210), classes, teachers and administrators, and authorization information. Data store 130 can further store information regarding communication procedures associated with distributing information associated with a student portfolio.

In an aspect, the information stored by data store 130 is centrally available through student portfolio system. For example, data store 130 can be provided on a server computer that can be accessed via a network. The network can be public or private. According to this example, data store 130 can be provided on a server computer that integrates student portfolio system 100. In another aspect, data store 130 can include a federation of multiple data stores internal and/or external to student portfolio system 100.

Access component 150 is configured to provide access to data store 130, and in particular, the portfolio's 140 stored therein. In an aspect, access component is configured to provide access to authorized users of student portfolio system 100 and authorized users of specific student portfolios 140. For example, those authorized to access a student portfolio can include the student to which the portfolio belong, a graduated student of associated with a portfolio, parents of the student, teachers or supervisors of the student, and administrative personnel. A variety of mechanisms can be employed to authorize access to a student portfolio. For example, users can be authorized by providing authentication information to the access component in the form of an identification name/number and a password. In an aspect, the identification number and/or password can be associated with a client device, (e.g. an IP address or phone number) that is employed to interact with system 200.

A client device can include any suitable computing device associated with a user and configured to interact with portfolio system 100 (or additional systems described in this disclosure). For example, a client device can include a desktop computer, a laptop computer, a smart-phone, a tablet personal computer (PC), or a PDA. As used in this disclosure, the terms “individual” or “user” refer to a person, entity, system, or combination thereof that employs student portfolio system 100 (or additional systems described in this disclosure). In an aspect, a client device can be configured to access a portfolio 140 via a network such as for example the Internet, intranet, or cellular service.

In an embodiment, access component 150 can be configured to provide different levels of access to portfolio 140. A level of access can directly relates to the manner in which a user can interact with a portfolio. For example, a student for who a portfolio belongs may be able to view his or her portfolio and edit and provide information for the portfolio with respect to predetermined sections. According to this example, the student may be authorized to write notes in a journal area. However, the student may be restricted from editing and manipulating certain information section of his or her portfolio , such as those sections pertaining to grades or medical information, based on the student's access information. On the contrary, a teacher or administrator may have a different level of access which permits the teacher or administrator to edit grade or medical information.

Student portfolio 140 described herein serve a variety of purposes. In an aspect a student portfolio works as a tool of data collection, that is, accumulation, storage, and online translation of an individual school student's database about various directions and fields of the student's educational and extra-curricular social activities. In another aspect, student portfolio serves as a mirror of an integral picture (way of representing and interpreting) a student's educational and social actions and achievements. In yet another aspect, a student portfolio serves as a tool of social control and social influence on a student on the part of adults and administrators in order to correct or guide the student's educational and/or social activities.

As a data collection tool, the student portfolio collects and stores individual data about the activities and successes of a student in education and social life, and provides honest accounting for quantitative and qualitative indicators of students' educational and social actions. Student portfolio systems disclosed herein automatically record in a portfolio for a student, real facts of the student's actions performed (for example, the fact of going to the library, the fact of taking part in a competition or a project, as well as all other facts that are recorded automatically), as well as messages about facts that are generated by the student or the students teacher (for example, a message about visiting a workshop or a coterie, a message about participation in a competition that was held outside the given educational-social network). Thus, student portfolio systems disclose herein accumulate quantitative indicators of a school student's social activities in the portfolio.

At the same time, the systems disclosed herein also accumulate qualitative indicators of a student's educational and social activities (i.e. the systems automatically records points and updates their scores) that the student receives as the result of written tests, final tests, and final results in various subjects at the end of each academic term or each trimester, as well as points that the student receives for participation in competitions and projects following the voting results. In addition to numeric data on the quality of education, such as points and grades, the systems also automatically record subject teachers' commentaries that these teachers enter in an electronic register against the last name of each student at the end of each term or each trimester. Similarly, the systems also record teachers' opinions on students' competition entries and work in projects (i.e. commentaries by teachers who supervise competitions and projects. In addition, the portfolio also accumulates quantitative data about reading activity and qualitative indicators of students' reading competences, which are automatically entered into the portfolio from an electronic interactive library.

As a way of representing and interpreting a student's educational and social actions and achievements, portfolios 140 provide a medium for a student to view the integral picture of his or her educational and social life. Moreover, the picture can be accessed not only by the student but also by his or her form master and parents. As a result, the student will be motivated by an improved degree of students' social responsibility before his or her school community and parents.

Further, the fact that school students themselves can take part in the formation of this picture and correct the already created and formed picture strengthens the self-esteem of students and serves either as an incentive to show their social activity or as an incentive to create an illusion of social activity, which is also an important aspect in the process of the social development of school students (the recognition by a school student of the necessity to create such an illusion is the manifestation of his/her social maturity). For example, students can elect to take part in additional educational and social activities in order to improve their overall portfolio. Moreover, the complex structure of the portfolio, such as the fact that the portfolio includes various types of social activities of students and not only their educational achievements, is an important compensatory tool in those cases where the low-level results of a student's educational activity are compensated by his/her activities in various spheres of social life. For example, if a student is unable to achieve high educational results, he or she may improve his or her portfolio's rating by applying for various social activities. In another example if a student is unable to achieve good results in various social activities, he or she can display enough social maturity not so much by participating as by logging in to various portfolio sections and improving the quantitative indicators of his or her social activity.

Portfolios described herein can also serve as a tool of social control. The electronic data collection and storage features of systems disclosed herein make it possible to create an honestly formed portfolio of a school student at least in part because aspects of data collection are beyond student control. Since the portfolio provides for both general and differentiated pictures of a student's educational and social activities at any stage of the student's stay at school, it can be thoroughly analyzed both by adult members of the school community/the form master and subject teachers (on the initiative and with assent of the form master), the school administration, and the school psychologist/and by the student's parents or those who take care of his or her life and self-determination. For the educational community and parents, the portfolio may thus become a tool of social influence on school students, as well as a tool of planning their future.

On the other hand, an honestly formed electronic portfolio may accompany a school student in his or her transfer to another school (this will help the teachers' community of that other school to painlessly adapt the newcomer to a new team), on his or her entry to a higher educational establishment (the portfolio's rating discussed supra, may serve as a component of an admittance requirement), and under military conscription (the health certificate of a school student in this latter case will help save on medical examinations).

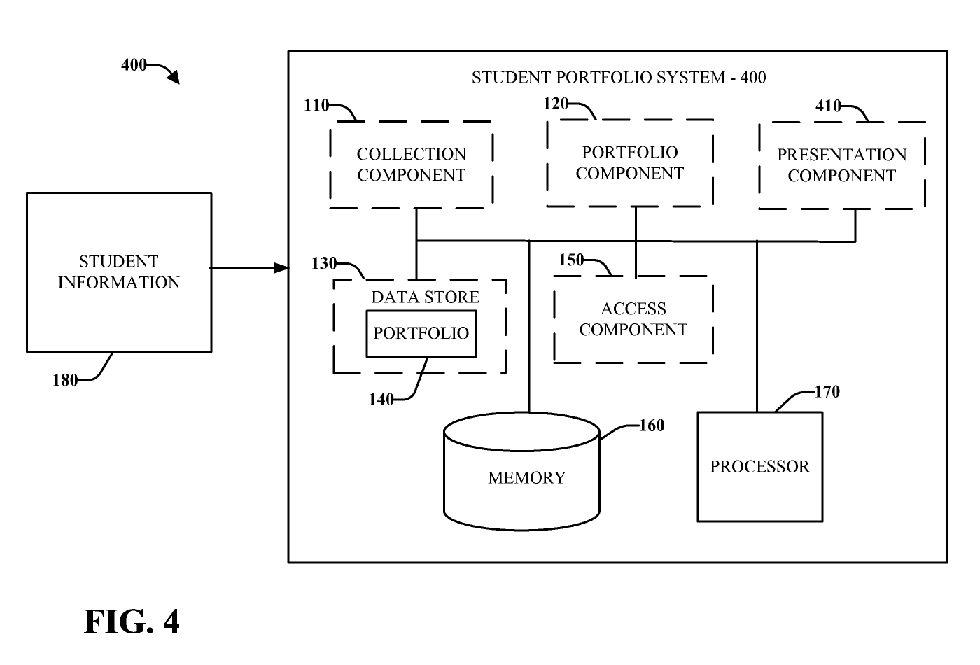

Turning now to FIG. 4, presented is another exemplary non-limiting embodiment of a student portfolio system 400 in accordance with the subject disclosure. System 400 includes the components of system 100 with the addition of presentation component 410. In an aspect, a presentation component 410 is configured present a portfolio based on its organization structure. For example, presentation component 410 can present a portfolio based on the various categories the information is separated into. According to this example, a student may desire to view only information regarding grades for a particular class, or information regarding all grades received in classes over the past two years.

In an embodiment, presentation component 410 is configured to present a portfolio in different manner and with different functionality depending on the viewer based on an access level of the viewer. For example, the presentation component my present a portfolio in a non-editable format to a parent while presenting the portfolio in an editable format to the student for which the portfolio belongs.

In addition, respective devices often have different capabilities and limitations (e.g., screen size, decoders...). In an aspect, the presentation component 410 can provide presentation options in accordance with different device capabilities or limitations. For example, data rendering capabilities may be more limited in a mobile device (e.g., a smart-phone) than in a fixed computing device (e.g., a desktop computer), more effort may be required of a user to consume content such as a video (or other information) from the mobile device than would be required of the user in viewing the same video from a fixed computing device. In addition, because displays of various mobile devices are often smaller than displays in fixed computing devices, it may be possible only to display a relatively small amount of information at any given time on a mobile device. The presentation component 410 can thus optimize display of options and content for respective devices. Finally, data connections between a mobile device and various networked resources (e.g., the Internet) may be slower than corresponding data connections between a fixed computing device and the same networked resources. Accordingly, the presentation component 410 can generate user options to account for variations in device functionality and available bandwidth for consumption and rendering of content. In view of the above, in an aspect, the presentation component 410 can present content in various formats and/or in accordance with various display mediums.

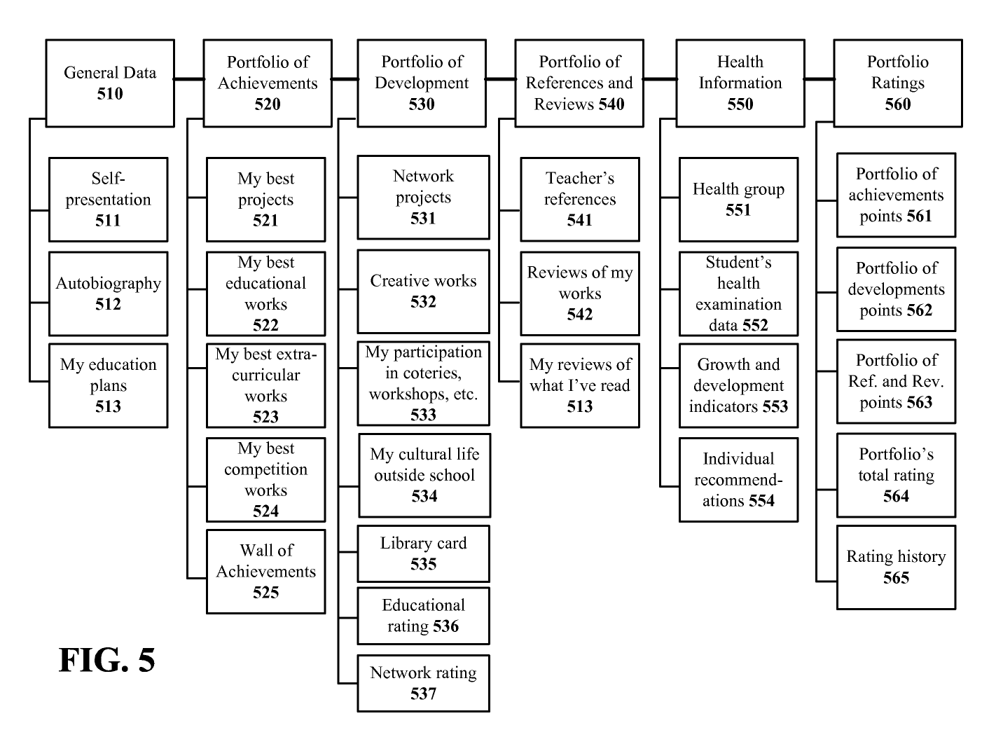

FIG. 5 presents a block diagram 500 of an example organizational scheme which the presentation component 410 may follow when organizing student information in a portfolio for a student. As seen in FIG. 5, in an embodiment, a portfolio can be organized into categories including general data 510, portfolio of achievements 520, portfolio of development 530, portfolio of reference and reviews 540, health information 550, and portfolio ratings. Each of the categories can further include sub-categories. In an aspect, the general data 510 category can include sub-categories of self-presentation 511, which can include information received automatically from an educational portal, autobiography information 512, which can include information received from a student or from another external source, and education plans 513, which can include information such as goals and plans provided by the student, teacher, or another external source.

The category of portfolio of achievements 520, can further include the following sub-categories: my best projects 521, which can include information received automatically from the educational social network; my best educational works 522, which can include information received automatically from an educational portal; my best extra-curricular works 523, which can include information received automatically from the educational social network; my best compilation works 524, which can include information received automatically from the education portal; and wall of achievements 525, which can include information received automatically from the educational portal.

The category of portfolio of development 530 can further include the following sub-categories: network projects 531, which can include information received automatically from the educational social network; creative works 532, which can include information received automatically from the educational portal; my participation in coteries, workshops, and etc. 533, which can include information received automatically or manually from external data; my cultural life outside of school 534, which can include information received manually or automatically from external data; library card 535, which can include information received automatically from the electronic interactive library; educational rating 536, which can include information received automatically from the educational portal; and network rating 537, which can include information received automatically from the educational portal.

The category of references and reviews 540 can further include the following sub-categories: teachers references 541, which can include information received automatically from the educational portal; reviews of my works 542, which can include information received automatically from my educational portal; and my reviews of what I have read 543, which can include information received automatically from the electronic interactive library.

The category of health information 550, can further include the following sub-categories: health group 551, which can include information received automatically from an networked medical service or received manually by administrative personnel; student's health examination information 552, which can include information received automatically from an networked medical service or received manually by administrative personnel; growth and development indicators 553, which can include information received automatically from an networked medical service or received manually by administrative personnel; and individual recommendations 554, which can include information received automatically from an networked medical service or received manually by administrative personnel.

The category of portfolio's ratings can include the following sub-categories: portfolio of achievements' points 561, portfolio of developments' points 562, portfolio of references and reviews' points 563, portfolios total rating 564, and rating history 565. The information of the portfolio's rating category 560 and its' subcategories can be generated internally by the subject student portfolio's system as discussed infra with respect to analysis component.

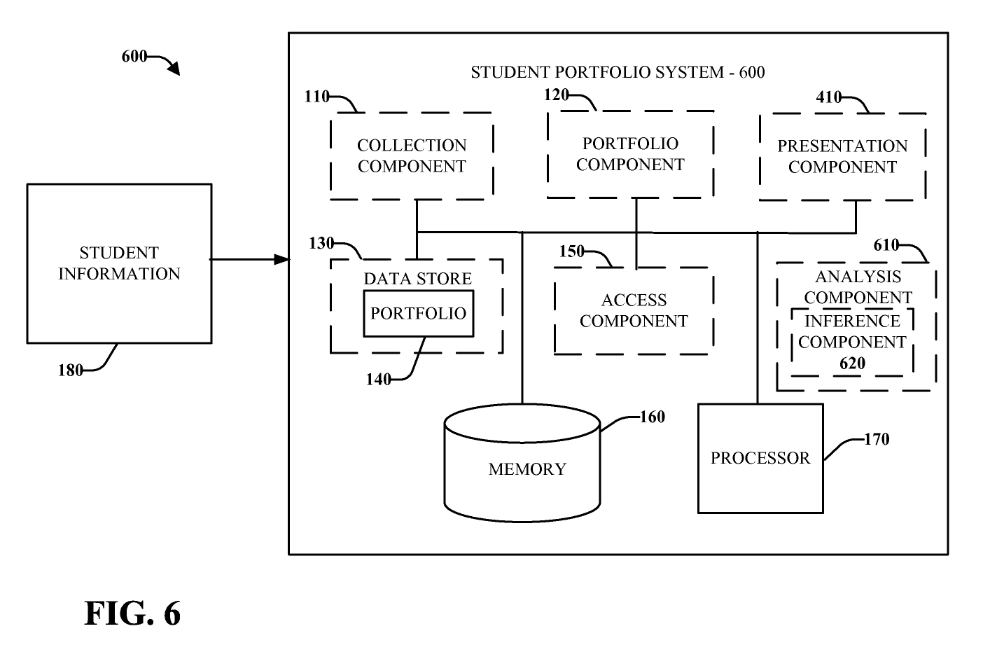

Looking now to FIG. 6, presented is another exemplary non-limiting embodiment of a student portfolio system 600 in accordance with the subject disclosure. System 600 includes the components of system 400 with the addition of analysis component 610 which can further include inference component 620. As discussed supra, a portfolio can include a variety of educational activity information and social activity information relating to both quantitative and qualitative features. In an aspect, analysis component 610 is configured to analyze the qualitative and quantitative information of a student's portfolio to determine a values or scores associated with the student's academic and social performance. For example, the analysis component can determine cumulative score representative of the student's academic performance, and/or a cumulative score representative of the student's social performance. In another example, the analysis component can determine a breakdown of scores which influence the cumulative scores. For example, the analysis component 610 can determine a score associated with a student's qualitative academic performance and quantitative academic performance where both score influence a cumulative score representative of academic performance in general. In another example, the analysis component may determine qualitative and/or quantitative scores associated with specific subject areas or time frames of the student's education.

In an embodiment, analysis component 610 configured to determine points associated with received student information 180 provided in a profile. In an aspect, the information includes points associated therewith. For example, social activity information may include a score associated with participation in a number of social activities. In another aspect, the analysis component is configured to employ pre-defined parameters defined in data store 130 equating various educational and social activities with points, in order to determine points for a student's educational and social activities included in the student's profile 140. The analysis component 610 is further configured to determine a score associated with the information in a student's portfolio that reflects at least one of student educational performance or student social performance, and associate the score with the portfolio. For example, referring back to FIG. 5, the analysis component 610 can determine scores for the various subsections of a student's portfolio, such a student's achievements, developments, and/or references and reviews, based on the respective points received for subsections. The analysis component can further determine cumulative score or total rating for a student's portfolio based on the scores determined for the various subsections. In an aspect, the analysis component can determine total scores in a dynamic manner each time a student receives points associated with any educational or social activity. In another aspect, the analysis component 610 can determine scores at predetermined intervals, such as every day, every week, every semester, and etc.

In another aspect, analysis component 610 is configured to analyze information in a student's portfolio to identify patterns in the information. For example, the analysis component may determine a pattern where a student repeatedly performs low in a specific subject area, or repeatedly performs low in another subject area when the student is not taking a certain medication or when the student is not participating in a particular social activity. The analysis component 610 is further configured to determine at least one of student academic strengths, student academic weaknesses, student social strengths, or student social weaknesses, based on the patterns. For example, the analysis component 610 may determine that a student has poor reading skills yet high math skill, or that a student is not good in large groups, but functions well in small groups. The analysis component can further provide a computer generated report identifying the student's strengths and weaknesses and include the report in the student's portfolio 140.

In addition, analysis component 610 can further include inference component 620. In an aspect, inference component 620 is configured to infer at least one of an educational or a social action to perform based on at least one of the student academic strengths, the student academic weaknesses, the student social strengths, or the student social weaknesses as determined by the analysis component. For example, the inference component 620 may infer that a student should participate in tutoring or not take an advanced math class and participate in a coterie at the same time. In another aspect, the inference component 620 may determine actions the student should perform or path the student should take based on the students strengths and weaknesses. For example, the inference component 620 may determine possible focus areas of study or career choices for the student based on the student's strengths and weaknesses.

In order to provide for or aid in the numerous inferences described in this disclosure (including inferring a student's strengths and weaknesses as well as actions for the student to perform based on those strengths and weaknesses, and etc), inference component 310 can examine the entirety or a subset of data, including multiple profiles in data store 130 to which it is granted access, and can provide for reasoning about a student's strengths and weaknesses as well as actions for the student to perform based on those strengths and weaknesses. An inference can be employed to identify a specific context or action, or can generate a probability distribution over states, for example. The inference can be probabilistic - that is, the computation of a probability distribution over states of interest based on a consideration of data and events. An inference can also refer to techniques employed for composing higher-level events from a set of events or data.

Such inference can result in construction of new events or actions from a set of observed events or stored event data, whether or not the events are correlated in close temporal proximity, and whether the events and data come from one or several event and data sources. Various classification (explicitly or implicitly trained) schemes or systems (e.g., support vector machines, neural networks, expert systems, Bayesian belief networks, fuzzy logic, data fusion engines, etc.) can be employed in connection with performing automatic or inferred action in connection with the claimed subject matter.

A classifier can map an input attribute vector, x=(x1, x2, x3, x4, xn), to a confidence that the input belongs to a class, such as by f(x)=confidence(class). Such classification can employ a probabilistic or statistical-based analysis (e.g., factoring into the analysis utilities and costs) to prognose or infer an action that a user desires to be automatically performed. A support vector machine (SVM) is an example of a classifier that can be employed. The SVM operates by finding a hyper-surface in the space of possible inputs, where the hyper-surface attempts to split the triggering criteria from the non-triggering events. Intuitively, this makes the classification correct for testing data that is near, but not identical to training data. Other directed and undirected model classification approaches include, e.g., naïve Bayes, Bayesian networks, decision trees, neural networks, fuzzy logic models, and probabilistic classification models providing different patterns of independence can be employed. Classification as used in this disclosure also is inclusive of statistical regression that is utilized to develop models of priority.

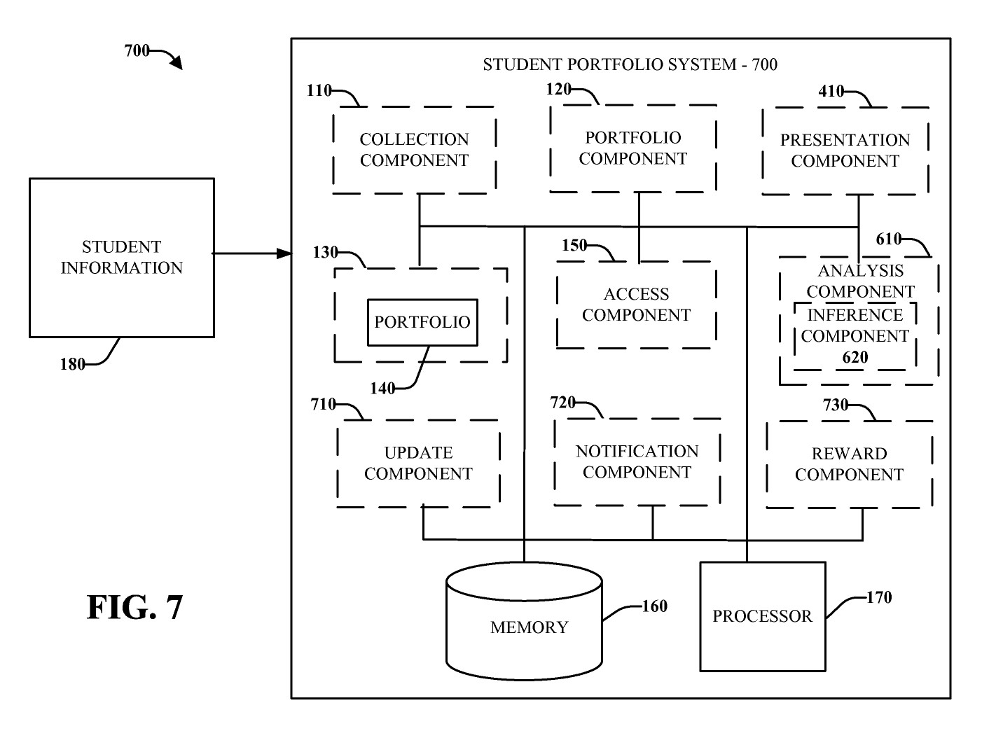

With reference to FIG. 7, presented is another exemplary non-limiting embodiment of a student portfolio system 700 in accordance with the subject disclosure. System 700 includes the components of system 400 with the addition of update component 710, notification component 720, and reward component 730. In an embodiment, update component 710 is configured to update portfolio information. In particular, systems disclosed herein, (i.e. systems 100, 400, 600, and 700), are configured to continuously receive information about a student through the students educational career and associated the information in the student's portfolio. In an aspect, the information is received automatically in response to generation of the information at an external electronic source. In another aspect, individuals, such as the student him or herself, a teacher or otherwise authorized personnel, can manually input the information into the portfolio.

In an aspect, update component 710 is configured to update scores in the portfolio in response to receipt of new information by the collection component 110. For example, the update component 710 can instruct the analysis component 610 to re-calculate a score in a student's portfolio including a cumulative score or total rating for a student's portfolio based or a score for a subsection. In an aspect, update component can instruct the analysis component 610 to re-calculate scores in a dynamic manner each time a student receives points associated with any educational or social activity. In another aspect, the updated component 710 can instruct the analysis component 610 to re-calculate scores at predetermined intervals, such as every day, every week, every semester, and etc.

In another aspect, the update component 710 is configured to replace old or outdated information in a student's portfolio with new information. According to this aspect, the update component 710 is configured to update a student's strength and weakness determinations and inferences as well as inferred actions based on those determinations and inferences. In another aspect, the updated component 710 is configured to update factual information regarding a student. For example, if a student withdrawals from a class or engages in a new activity, the update component 710 is configured to ensure the information in the students portfolio accurately depicts a student's educational and social behavior and achievements.

System 700 further includes a notification component 720. Notification component is configured to provide notifications in response to the occurrence of triggers associated with a student's portfolio. In this respect, the notification component 720 is configured to automatically provide notifications based on changes in a student's portfolio. For example, in an aspect, the notification component 720 is configured to provide a notification in response to a score associated with the student's portfolio falling below a predetermined threshold. According to this example, the student's parents or teacher may receive the notification. Similarly, a trigger could include a score associated with the student's portfolio exceeding a predetermined threshold. In another example, a trigger could include repeated missed days in class, withdrawing from a class, receiving an award, or winning a competition. In an aspect, triggers for notification can be determined by the educational institution which the student attends and apply to all student profiles. In another aspect, a student's teacher or administrator could institute triggers specific triggers tailored to the student.

In an embodiment, the notification component 720 can send a notification as an electronic communication via a networked or cellular communication. For example, the notification component could send a notification as an email, text message, voicemail, or multi-media message. In another aspect, the notification component 720 can post a general notification to shared portal, such as an electronic blog or bulletin board intended to be viewed by multiple individuals. For example, the notification component 720 could post a message on a communal bulletin board with the names of the students who won a competition in response to a trigger associated with each of the students portfolios associated with receipt of student information indicating the winning of the competition.

Similar to notification component, system 700 can further include a reward component 730. Reward component 730 can be configured to provide a student with a reward in response to triggers associated with the student's profile. For example, in an aspect, the reward component 730 is configured to provide a reward in response to a score in student's profile s exceeding a predetermined threshold, or in response to receipt of an award by the student. In an aspect, the reward can be in the form of a coupon or gift certificate sent electronically to the student as an email, text message, or multi-media message.

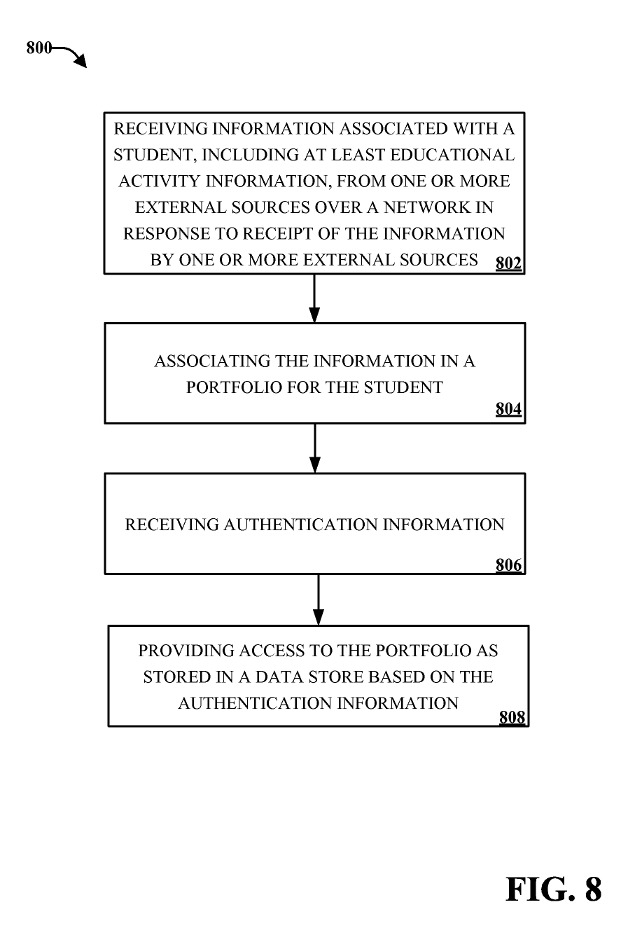

FIG. 8 illustrates a methodology or flow diagram in accordance with certain aspects of this disclosure. While, for purposes of simplicity of explanation, the methodologies are shown and described as a series of acts, the disclosed subject matter is not limited by the order of acts, as some acts may occur in different orders and/or concurrently with other acts from that shown and described herein. For example, those skilled in the art will understand and appreciate that a methodology can alternatively be represented as a series of interrelated states or events, such as in a state diagram. Moreover, not all illustrated acts may be required to implement a methodology in accordance with the disclosed subject matter. Additionally, it is to be appreciated that the methodologies disclosed in this disclosure are capable of being stored on an article of manufacture to facilitate transporting and transferring such methodologies to computers or other computing devices. The term article of manufacture, as used in this disclosure, is intended to encompass a computer program accessible from any computer-readable device or storage media.

Referring now to FIG. 8, presented is a flow diagram of an example application of systems disclosed in this description accordance with an embodiment. In an aspect, exemplary methodology 800 of a student portfolio system is stored in a memory and utilizes a processor to execute computer executable instructions to perform functions. At 802, information associated with a student is received, including at least educational activity information, from one or more external sources over a network in response to receipt of the information by one or more external sources. In an aspect, social activity information can also be received. Further, in an aspect, the information is received from an external electronic source, such as an interactive electronic application, over a network, in response to receipt of the information by the external electronic source.

Then at 804, the information is associated in a portfolio for the student. It should be appreciated that the portfolio can remain stored in a data store or be previously stored in a data store prior to the association of the information therein. At 806, authentication information is received, and, at 810, access to the portfolio as stored in a data store is provided based on the authentication information.

### Example Operating Environments

The systems and processes described below can be embodied within hardware, such as a single integrated circuit (IC) chip, multiple ICs, an application specific integrated circuit (ASIC), or the like. Further, the order in which some or all of the process blocks appear in each process should not be deemed limiting. Rather, it should be understood that some of the process blocks can be executed in a variety of orders, not all of which may be explicitly illustrated in this disclosure.

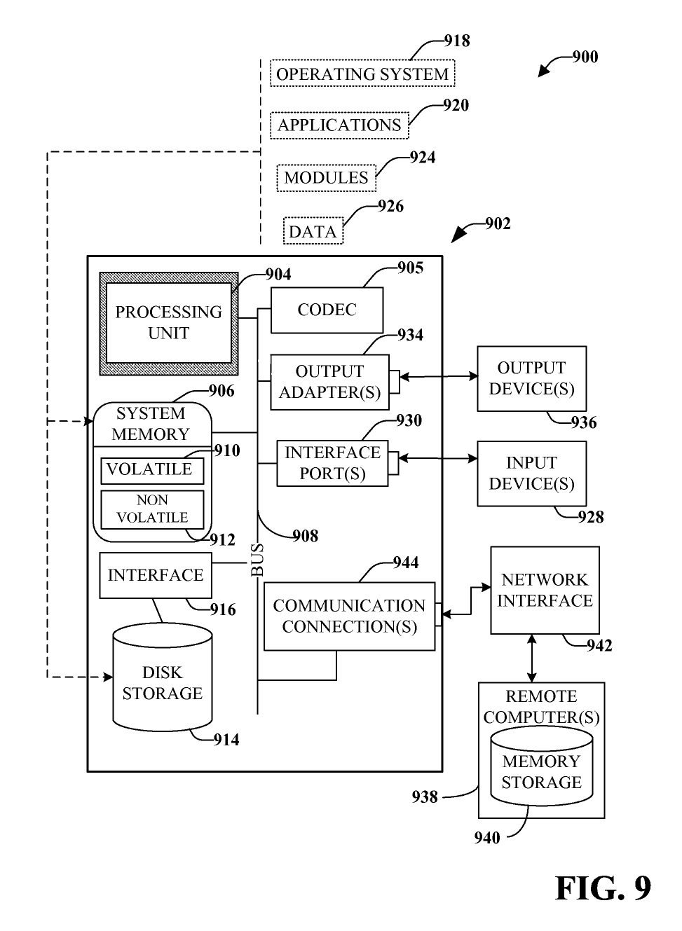

With reference to FIG. 9, a suitable environment 900 for implementing various aspects of the claimed subject matter includes a computer 902. The computer 902 includes a processing unit 904, a system memory 906, a codec 905, and a system bus 908. The system bus 908 couples system components including, but not limited to, the system memory 906 to the processing unit 904. The processing unit 904 can be any of various available processors. Dual microprocessors and other multiprocessor architectures also can be employed as the processing unit 904.

The system bus 908 can be any of several types of bus structure(s) including the memory bus or memory controller, a peripheral bus or external bus, and/or a local bus using any variety of available bus architectures including, but not limited to, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Card Bus, Universal Serial Bus (USB), Advanced Graphics Port (AGP), Personal Computer Memory Card International Association bus (PCMCIA), Firewire (IEEE 1394), and Small Computer Systems Interface (SCSI).

The system memory 906 includes volatile memory 910 and non-volatile memory 912. The basic input/output system (BIOS), containing the basic routines to transfer information between elements within the computer 902, such as during start-up, is stored in non-volatile memory 912. In addition, according to one or more embodiments, codec 905 may include at least one of an encoder or decoder, wherein the at least one of an encoder or decoder may consist of hardware, a combination of hardware and software, or software. Although, codec 905 is depicted as a separate component, codec 905 may be contained within non-volatile memory 912. By way of illustration, and not limitation, non-volatile memory 912 can include read only memory (ROM), programmable ROM (PROM), electrically programmable ROM (EPROM), electrically erasable programmable ROM (EEPROM), or flash memory. Volatile memory 910 includes random access memory (RAM), which acts as external cache memory. According to present aspects, the volatile memory may store the write operation retry logic (not shown in FIG. 9) and the like. By way of illustration and not limitation, RAM is available in many forms such as static RAM (SRAM), dynamic RAM (DRAM), synchronous DRAM (SDRAM), double data rate SDRAM (DDR SDRAM), and enhanced SDRAM (ESDRAM.

Computer 902 may also include removable/non-removable, volatile/non-volatile computer storage medium. FIG. 9 illustrates, for example, disk storage 914. Disk storage 914 includes, but is not limited to, devices like a magnetic disk drive, solid state disk (SSD) floppy disk drive, tape drive, Jaz drive, Zip drive, LS-70 drive, flash memory card, or memory stick. In addition, disk storage 914 can include storage medium separately or in combination with other storage medium including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 914 to the system bus 908, a removable or non-removable interface is typically used, such as interface 916.

It is to be appreciated that FIG. 9 describes software that acts as an intermediary between users and the basic computer resources described in the suitable operating environment 900. Such software includes an operating system 918. Operating system 918, which can be stored on disk storage 914, acts to control and allocate resources of the computer system 902. Applications 920 take advantage of the management of resources by operating system 718 through program modules 924, and program data 926, such as the boot/shutdown transaction table and the like, stored either in system memory 906 or on disk storage 914. It is to be appreciated that the claimed subject matter can be implemented with various operating systems or combinations of operating systems.

A user enters commands or information into the computer 902 through input device(s) 928. Input devices 928 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 904 through the system bus 908 via interface port(s) 930. Interface port(s) 930 include, for example, a serial port, a parallel port, a game port, and a universal serial bus (USB). Output device(s) 936 use some of the same type of ports as input device(s) 928. Thus, for example, a USB port may be used to provide input to computer 902, and to output information from computer 902 to an output device 936. Output adapter 934 is provided to illustrate that there are some output devices 936 like monitors, speakers, and printers, among other output devices 936, which require special adapters. The output adapters 934 include, by way of illustration and not limitation, video and sound cards that provide a means of connection between the output device 936 and the system bus 908. It should be noted that other devices and/or systems of devices provide both input and output capabilities such as remote computer(s) 938.

Computer 902 can operate in a networked environment using logical connections to one or more remote computers, such as remote computer(s) 938. The remote computer(s) 938 can be a personal computer, a server, a router, a network PC, a workstation, a microprocessor based appliance, a peer device, a smart phone, a tablet, or other network node, and typically includes many of the elements described relative to computer 902. For purposes of brevity, only a memory storage device 940 is illustrated with remote computer(s) 938. Remote computer(s) 938 is logically connected to computer 902 through a network interface 942 and then connected via communication connection(s) 944. Network interface 942 encompasses wire and/or wireless communication networks such as local-area networks (LAN) and wide-area networks (WAN) and cellular networks. LAN technologies include Fiber Distributed Data Interface (FDDI), Copper Distributed Data Interface (CDDI), Ethernet, Token Ring and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 944 refers to the hardware/software employed to connect the network interface 942 to the bus 908. While communication connection 944 is shown for illustrative clarity inside computer 902, it can also be external to computer 902. The hardware/software necessary for connection to the network interface 942 includes, for exemplary purposes only, internal and external technologies such as, modems including regular telephone grade modems, cable modems and DSL modems, ISDN adapters, and wired and wireless Ethernet cards, hubs, and routers.

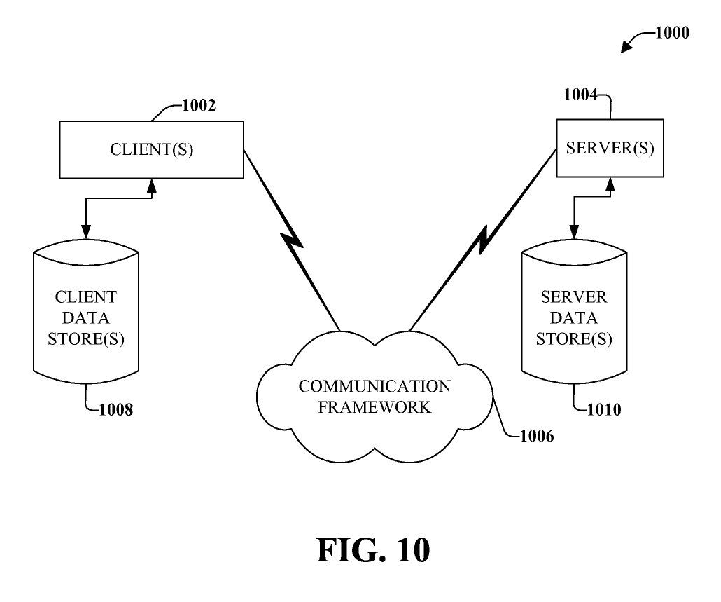

Referring now to FIG. 10, there is illustrated a schematic block diagram of a computing environment 1000 in accordance with this disclosure. The system 1000 includes one or more client(s) 1002 (e.g., laptops, smart phones, PDAs, media players, computers, portable electronic devices, tablets, and the like). The client(s) 1002 can be hardware and/or software (e.g., threads, processes, computing devices). The system 1000 also includes one or more server(s) 1004. The server(s) 1004 can also be hardware or hardware in combination with software (e.g., threads, processes, computing devices). The servers 1004 can house threads to perform transformations by employing aspects of this disclosure, for example. One possible communication between a client 1002 and a server 1004 can be in the form of a data packet transmitted between two or more computer processes wherein the data packet may include video data. The data packet can include metadata, e.g., associated contextual information, for example. The system 1000 includes a communication framework 1006 (e.g., a global communication network such as the Internet, or mobile network(s)) that can be employed to facilitate communications between the client(s) 1002 and the server(s) 1004.

Communications can be facilitated via a wired (including optical fiber) and/or wireless technology. The client(s) 1002 include or are operatively connected to one or more client data store(s) 1008 that can be employed to store information local to the client(s) 1002 (e.g., associated contextual information). Similarly, the server(s) 1004 are operatively include or are operatively connected to one or more server data store(s) 1010 that can be employed to store information local to the servers 1004.

In one embodiment, a client 1002 can transfer an encoded file, in accordance with the disclosed subject matter, to server 1004. Server 1004 can store the file, decode the file, or transmit the file to another client 1002. It is to be appreciated, that a client 1002 can also transfer uncompressed file to a server 1004 and server 1004 can compress the file in accordance with the disclosed subject matter. Likewise, server 1004 can encode video information and transmit the information via communication framework 1006 to one or more clients 1002.

The illustrated aspects of the disclosure may also be practiced in distributed computing environments where certain tasks are performed by remote processing devices that are linked through a communications network. In a distributed computing environment, program modules can be located in both local and remote memory storage devices.

Moreover, it is to be appreciated that various components described in this description can include electrical circuit(s) that can include components and circuitry elements of suitable value in order to implement the embodiments of the subject embodiment(s). Furthermore, it can be appreciated that many of the various components can be implemented on one or more integrated circuit (IC) chips. For example, in one embodiment, a set of components can be implemented in a single IC chip. In other embodiments, one or more of respective components are fabricated or implemented on separate IC chips.

What has been described above includes examples of the embodiments of the present invention. It is, of course, not possible to describe every conceivable combination of components or methodologies for purposes of describing the claimed subject matter, but it is to be appreciated that many further combinations and permutations of the subject embodiments are possible. Accordingly, the claimed subject matter is intended to embrace all such alterations, modifications, and variations that fall within the spirit and scope of the appended claims. Moreover, the above description of illustrated embodiments of the subject disclosure, including what is described in the Abstract, is not intended to be exhaustive or to limit the disclosed embodiments to the precise forms disclosed. While specific embodiments and examples are described in this disclosure for illustrative purposes, various modifications are possible that are considered within the scope of such embodiments and examples, as those skilled in the relevant art can recognize.

In particular and in regard to the various functions performed by the above described components, devices, circuits, systems and the like, the terms used to describe such components are intended to correspond, unless otherwise indicated, to any component which performs the specified function of the described component (e.g., a functional equivalent), even though not structurally equivalent to the disclosed structure, which performs the function in the disclosure illustrated exemplary aspects of the claimed subject matter. In this regard, it will also be recognized that the various embodiments includes a system as well as a computer-readable storage medium having computer-executable instructions for performing the acts and/or events of the various methods of the claimed subject matter.

The aforementioned systems/circuits/modules have been described with respect to interaction between several components/blocks. It can be appreciated that such systems/circuits and components/blocks can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it should be noted that one or more components may be combined into a single component providing aggregate functionality or divided into several separate sub-components, and any one or more middle layers, such as a management layer, may be provided to communicatively couple to such sub-components in order to provide integrated functionality. Any components described in this disclosure may also interact with one or more other components not specifically described in this disclosure but known by those of skill in the art.

In addition, while a particular feature of the subject embodiments may have been disclosed with respect to only one of several implementations, such feature may be combined with one or more other features of the other implementations as may be desired and advantageous for any given or particular application. Furthermore, to the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

As used in this application, the terms “component,” “module,” “system,” or the like are generally intended to refer to a computer-related entity, either hardware (e.g., a circuit), a combination of hardware and software, software, or an entity related to an operational machine with one or more specific functionalities. For example, a component may be, but is not limited to being, a process running on a processor (e.g., digital signal processor), a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers. Further, a “device” can come in the form of specially designed hardware; generalized hardware made specialized by the execution of software thereon that enables the hardware to perform specific function; software stored on a computer readable storage medium; software transmitted on a computer readable transmission medium; or a combination thereof

Moreover, the words “example” or “exemplary” are used in this disclosure to mean serving as an example, instance, or illustration. Any aspect or design described in this disclosure as “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Computing devices typically include a variety of media, which can include computer-readable storage media and/or communications media, in which these two terms are used in this description differently from one another as follows. Computer-readable storage media can be any available storage media that can be accessed by the computer, is typically of a non-transitory nature, and can include both volatile and nonvolatile media, removable and non-removable media. By way of example, and not limitation, computer-readable storage media can be implemented in connection with any method or technology for storage of information such as computer-readable instructions, program modules, structured data, or unstructured data. Computer-readable storage media can include, but are not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or other tangible and/or non-transitory media which can be used to store desired information. Computer-readable storage media can be accessed by one or more local or remote computing devices, e.g., via access requests, queries or other data retrieval protocols, for a variety of operations with respect to the information stored by the medium.

On the other hand, communications media typically embody computer-readable instructions, data structures, program modules or other structured or unstructured data in a data signal that can be transitory such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

In addition to the various embodiments described in this disclosure, it is to be understood that other similar embodiments can be used or modifications and additions can be made to the described embodiment(s) for performing the same or equivalent function of the corresponding embodiment(s) without deviating there from. Still further, multiple processing chips or multiple devices can share the performance of one or more functions described in this disclosure, and similarly, storage can be effected across a plurality of devices. Accordingly, the invention is not to be limited to any single embodiment, but rather can be construed in breadth, spirit and scope in accordance with the appended claims.

What is claimed is:

1. A system, comprising:
at least one memory having stored thereon one or more computer executable components; and
a processor configured to facilitate execution of the one or more computer executable components stored in the at least one memory, the one or more computer executable components, comprising:
a collection component configured to receive information associated with a student, including at least educational activity information from one or more external sources over a network in response to receipt of the information by one or more external sources;
a portfolio component configured to associate the information in a portfolio for the student; and
an access component configured to provide access to the portfolio as stored in a data store.

2. The system of claim 1, wherein the collection component is configured to receive the information from two or more different external sources over the network in response to receipt of the information by the two or more external sources.

3. The system of claim 1, wherein the one or more external sources include an interactive educational application employed on a computer, and wherein the educational activity information includes quantitative and qualitative educational information generated through use of the interactive educational application.

4. The system of claim 1, wherein the one or more external sources include at least one of, an educational portal, an educational social network, or an electronic interactive library.

5. The system of claim 1, wherein the educational activity information includes qualitative academic performance information.

6. The system of claim 1, wherein the educational activity information includes at least one of: participation in or attendance of an educational event or activity, participation in a competition or a project, receipt of an achievement award, time spent at a library, time spent at a laboratory or studio, or reading activity.

7. The system of claim 1, wherein the information further includes social activity information associated with the student.

8. The system of claim 7, wherein the social activity information includes at least one of: participation in an extracurricular activity, participation in a social event or activity, participation in a competition or project, or participation in a coterie.

9. The system of claim 7, wherein the information further includes commentary regarding the educational activity information or the social activity information.

10. The system of claim 1, wherein the portfolio component is further configured to organize the portfolio into categories based on features of the information, and wherein the system further comprises:
a presentation component configured to present the portfolio based on the categories.

11. The system of claim 1, further comprising:
an analysis component configured to determine points associated with the information, analyze the information based on the points, determine a score associated with the information that reflects at least one of student educational performance or student social performance, and associate the score with the portfolio.

12. The system of claim 11, further comprising:
an update component configured to update the score in the portfolio in response to receipt of new information by the collection component.

13. The system of claim 11, further comprising:
a notification component configured to provide a notification in response to the score falling below a predetermined threshold.

14. The system of claim 11, further comprising:
a reward component configured to provide a reward in response to the score exceeding a predetermined threshold.

15. The system of claim 1, wherein the access component is configured to provide access to the portfolio in response to receiving authentication information authorizing access to the portfolio.

16. The system of claim 1, further comprising:
an analysis component configured to analyze the information in the portfolio, identify patterns in the information, and determine at least one of student academic strengths, student academic weaknesses, student social strengths, or student social weaknesses, based on the patterns.

17. The system of claim 16, further comprising:
an inference component configured to infer at least one of an educational or a social action to perform based on the at least one of the student academic strengths, the student academic weaknesses, the student social strengths, or the student social weaknesses.

18. A method, comprising:
employing at least one processor to facilitate executing computer executable instructions stored on at least one computer readable storage medium to perform operations, comprising:
receiving information associated with a student, including at least educational activity information, from one or more external sources over a network in response to receipt of the information by one or more external sources;
associating the information in a portfolio for the student;
receiving authentication information; and
providing access to the portfolio as stored in a data store based on the authentication information.

19. The method of claim 18, wherein the collection component is configured to receive the information from two or more different external sources over the network in response to receipt of the information by the two or more external sources.

20. The method of claim 18, wherein the one or more external sources include an interactive educational application employed on a computer, and wherein the educational activity information includes quantitative and qualitative educational information generated through use of the interactive educational application.

21. The method of claim 18, wherein the one or more external sources include at least one of, an educational portal, an educational social network, or an electronic interactive library.

22. The method of claim 18, wherein the educational activity information includes qualitative academic performance information.

23. The method of claim 18, wherein the educational activity information includes at least one of: participation in or attendance of an educational event or activity, participation in a competition or a project, receipt of an achievement award, time spent at a library, time spent at a laboratory or studio, or reading activity.

24. The method of claim 18, wherein the information further includes social activity information associated with the student.

25. The method of claim 24, wherein the social activity information includes at least one of: participation in an extracurricular activity, participation in a social event or activity, participation in a competition or project, or participation in a coterie.

26. The method of claim 24, wherein the information further includes commentary regarding the educational activity information or the social activity information.

27. The method of claim 18, further comprising:
organizing the portfolio into categories based on features of the information; and
presenting the portfolio based on the categories.

28. The method of claim 18, further comprising:
determining points associated with the information;
analyzing the information based on the points;
determining a score associated with the information that reflects at least one of student educational performance or student social performance; and
associating the score with the portfolio.

29. The method of claim 28, further comprising:
receiving new information associated with the student; and
updating the score in the portfolio in response to receiving the new information.

30. The method of claim 28, further comprising:
providing a notification in response to the score falling below a predetermined threshold.

31. The method of claim 28, further comprising:
providing a reward in response to the score exceeding a predetermined threshold.

32. The method of claim 18, further comprising:
analyzing the information in the portfolio;
identifying patterns in the information; and
determining at least one of student academic strengths, student academic weaknesses, student social strengths, or student social weaknesses, based on the patterns.

33. The method of claim 32, further comprising:
inferring at least one of an educational or a social action to perform based on the at least one of the student academic strengths, the student academic weaknesses, the student social strengths, or the student social weaknesses.

34. A computer-readable storage medium comprising computer-readable instructions that, in response to execution, cause a computing system to perform operations, comprising:
receiving information associated with a student, including at least educational activity information, from one or more external sources over a network in response to receipt of the information by one or more external sources;
associating the information in a portfolio for the student; and
providing access to the portfolio as stored in a data store.

35. The computer-readable storage medium of claim 34, wherein the one or more external sources include an interactive educational application employed on a computer, and wherein the educational activity information includes quantitative and qualitative educational information generated through use of the interactive educational application.

36. The computer-readable storage medium of claim 34, the operations further comprising:
determining points associated with the information;
analyzing the information based on the points;
determining a score associated with the information that reflects at least one of student educational performance or student social performance; and
associating the score with the portfolio.
